(19) United States
(12) Patent Application Publication
(10) Pub. No.: US 2008/0293927 A1
(43) Pub. Date: Nov. 27, 2008

(54) METHOD FOR PREPARING PELLETED LIGNOCELLULOSIC ION EXCHANGE MATERIALS

(75) Inventor: Bradley Scott Strahm, Sabetha, KS (US)

Correspondence Address: BRADLEY S. STRAHM, 1217 MEADOWLARK LANE, SABETHA, KS, 65534, US

(73) Assignee: THE XIM GROUP, LLC, SABETHA, KS (US)

(21) Appl. No.: 11/751,114

(22) Filed: May 21, 2007

(51) Int. Cl. C08L 97/02

(52) U.S. Cl. 530/500

(57) ABSTRACT

The invention discloses a method for preparing pelleted lignocellulosic ion exchange materials for use in a variety of industrial and municipal water treatment applications. The method involves milling, sifting, binding, extruding, cutting, and baking steps. The resultant pellet is suitable for use in ion exchange columns and can be regenerated.

### BACKGROUND OF THE INVENTION

1. Field of the Invention

The present invention is broadly concerned with a method for preparing pelleted lignocellulosic ion exchange materials and thereby producing a form of ion exchange pellets that are suitable for a wide variety of industrial and municipal water treatment applications, particularly where it is desirable to remove heavy metal contaminants from process, waste, or storm water. The method disclosed involves milling, sifting, mixing, binding, extruding, cutting, and baking processes to result in pellets that are insoluble in water and will withstand the ion exchange and regeneration processes.

2. Description of the Related Art

The related art and scientific literature describes the ability of lignocellulosic agricultural products to adsorb or bind metal ions from solution. Lignocellulosic materials that have been considered for this purpose include soybean hulls, cotton seed hulls, rice hulls, sugarcane bagasse, rice straw, rice bran, corn bran, almond hulls, almond shells macadamia nut hulls, peanut hulls, corn cobs, pecan shells, English walnut shells, and black walnut shells. It is desirable to have efficient ion adsorbing materials to treat industrial waste water, storm water, and municipal waste water to remove and in some cases recover contaminants such as heavy metals or other ionic materials.

It is also described in the related art that these lignocellulosic materials can be modified to enhance their metal ion adsorbing characteristics or to allow them to adsorb other materials and act as an ion exchange media. In particular, it is well-described that modification of these lignocellulosic materials greatly enhances their ability to adsorb metal ions from solution. For example, in Marshall, Wartelle, Boler, Johns, and Toles (Bioresource Technology, 69(1999):263-268) describe modification of soybean hulls by soaking in sodium hydroxide, rinsing with distilled water, then soaking in citric acid for various lengths of time. Following by soaking in citric acid, the hulls were dried, and then rinsed with water to remove excess citric acid. The modified hulls were then dried. Samples only treated with the sodium hydroxide soak were found to adsorb 26% more zinc ions than untreated hulls. Sodium hydroxide treated samples that were subsequently also treated with citric acid resulted in products that could adsorb up to 7.6 times more copper ions than untreated soy hulls. This increase in copper adsorption was attributed to an increase in carboxyl groups imparted to the hulls via reaction or modification by citric acid.

In another example Marshall, Wartelle, Boler, and Toles (Environmental Technology, 21(2000):601-607 describe modifying soybean hulls, almond hulls, cottonseed hulls, macadamia nut shells, and peanut shells by milling, soaking in sodium hydroxide, rinsing with water, then mixing with an acid. Acids used were citric acid, maleic acid, malic acid, succinic acid, or tartaric acid. The combined hull or shell and acid slurries were dried and then heat treated to 120° C. for 120 minutes to accomplish acid-modification. After acid modification, the hulls were rinsed with water to remove unreacted acid. The resulting acid-modified hulls were tested to determine their capacity to adsorb cadmium, copper, nickel, lead, and zinc ions from water. The results show that acid modification significantly increases the metal adsorbing ability of the lignocellulosic materials, with citric acid modification being the most effective. In addition, the metal ion adsorbing capability of these materials compares favorably with several commercial resins made from synthetic polymers.

In another example, Wartelle and Marshall (Advances in Environmental Research, 4(2000):1-7) describe acid-modification of sugarcane bagasse, peanut shells, macadamia nut hulls, rice hulls, cottonseed hulls, corn cob, soybean hulls, almond shells, almond hulls, pecan shells, English walnut shells, and black walnut shells by soaking in sodium hydroxide, rinsing, and blending with citric acid and heating to 120° C. for 90 minutes. The resulting acid modified materials were tested for copper ion uptake with results showing increases ranging from a reduction in copper ion uptake for black walnut shells and English walnut shells to a 2.6 times greater uptake for soybean hulls.

In another example, Marshall, Chatters, Wartelle and McAloon (Industrial Crops and Products, 14(2001): 191-199) estimate that citric acid modified soybean hulls can be manufactured at a lower cost compared to commercial synthetic polymer resins manufactured for the purpose of adsorbing metal ions from solution.

In another example, Marshall and Wartelle (Industrial Crops and Products, 18(2003):177-182) discuss a means of recycling acid to improve and optimize the production of citric acid-modified soybean hulls in a production situation.

In U.S. Pat. No. 7,098,327 to Marshall and Wartelle, a dual function ion exchange material is described whereby acid modified lignocellulosic materials are further modified with by cationization with dimethyloldihydroxyethylene urea and choline chloride or where lignocellulosic materials are first modified with by cationization with dimethyloldihydroxyethylene urea and choline chloride and then anionized with citric acid. This modification results in a product that can adsorb both positively charged and negatively charged ions.

While it is well demonstrated that lignocellulosic and especially modified lignocellulosic materials have very good ion adsorbing properties, the small particle size and wide particle size distribution of the granular and flaky materials is a problematic barrier to their use for at least two reasons. First, due to their small particle size and due to the wide particle size distribution (combination of large and very small particles), the pressure or head loss through the ion exchange column is excessively high. This is because the combination of large and small particles can pack very closely together resulting in a bed with a very small void volume and therefore a high resistance to water flow. Second, some the particles can be carried off in the water flow due to some combination of their small size, light density, and flaky shape resulting in water contaminated with ion exchange material as it exits the column.

Most ion exchange columns used in the industry are designed to use resin beads as the ion exchange medium. These beads are designed to selectively prefer certain ions which are desirable to remove from water based on the charged chemical groups contained in the resin structure. After the active sites on these resins are filled, an inexpensive regeneration material is circulated through the bed to remove the adsorbed ions and regenerate the resin for reuse. The resin beads are roughly spherical beads of approximately 1 to 2 millimeters diameter that are made of a cross linked polystyrene polymer. In most cases, small beads are preferred over large beads due to their larger surface area, however, when the bead size is too small, typically less than 1 millimeter diameter, the pressure or head loss through the column is excessively high. Commercial literature reveals that a uniform particle size distribution is preferred for ion exchange resin beads to reduce head loss and reduce resin loss.

The art acknowledges that it is desirable to have ion exchange materials in a bead or pelleted form rather than a powder or flake form. For example U.S. Pat. No. 5,578,547, 5,602,071, and 6,395,678 to Summers, et. al. describe binding activated carbon or peat moss with a variety of binders such as crosslinked poly (carboxylic acid), sodium silicate, polyamide, poly (acrylic acid), and polysulfone to form an ion exchange, metal ion adsorbing bead. In addition, U.S. Pat. Nos. 6,042,743 and 6,429,171 to Clemenson describe a method for processing peat for use in treating contaminated water whereby the end product is a pelletized product.

### SUMMARY OF THE INVENTION

The present invention relates to a method of binding ion adsorbing lignocellulosic materials into a bead or pellet form to create a resulting product that is suitable for use in commercial ion exchange columns for treating contaminated water. The method, as summarized in FIG. 1 of the drawings, includes milling lignocellulosic ion exchange materials to a proper particle size, combining the lignocellulosic ion exchange materials with a biopolymer binder, adding a liquid binder activator to form a dough, extruding or otherwise forming beads from the dough, and heating the beads to remove the liquid binder activator and to make the binder insoluble in water. In addition, particularly to create beads or pellets for storm water treatment, a water insoluble anti-microbial material can be added in the mixing step to inhibit growth of microbes such as mold, yeast, and bacteria.

The above described process results in a ion adsorbing lignocellulosic bead or pellet which is insoluble in water, permits penetration of contaminated water and access of the contaminants to active sites on the lignocellulosic materials, can be regenerated by circulation of a regenerating solution through the bed of beads, does not exhibit losses by either dissolving or being carried away in water flow and especially in the case of storm water treatment, does not exhibit growth of microbes such as mold, yeast or bacteria during inactive periods in the adsorption process.

### BRIEF DESCRIPTION OF THE DRAWING

FIG. 1 is a flow diagram of a method of creating pelleted lignocellulosic ion exchange materials.

### DETAILED DESCRIPTION OF THE PREFERRED EMBODIMENT

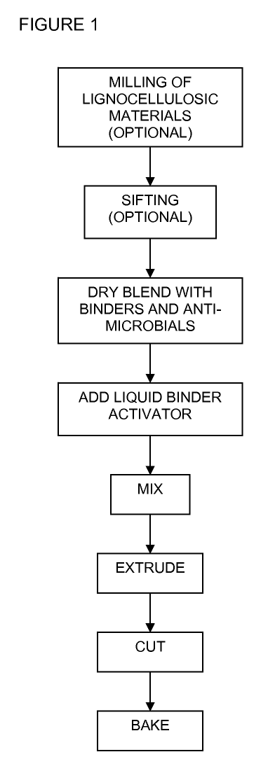

FIG. 1 provides a step-by-step explanation of a method of preparing pelleted lignocellulosic ion exchange materials starting with lignocellulosic materials that may or may not be modified to enhance their ion exchange characteristics as discussed the background information.

A method of the present invention for preparing pelleted lignocellulosic ion exchange materials begins at step 1 by optionally milling the lignocellulosic ion exchange materials. Milling of the lignocellulosic ion exchange materials is performed in the conventional manner using conventional milling equipment including such equipment as an impact mill, hammer mill, pin mill, burr mill, ball mill, air swept pulverizer, etc. The particle size of the milled lignocellulosic material should be small enough to pass through a sieve having 1 millimeter openings, preferably small enough to pass through a sieve having less than 0.8 millimeter openings, and most preferably small enough to pass through a sieve having 0.3 millimeter openings.

Step 2 of a process for preparing pelleted lignocellulosic ion exchange materials involves optionally sifting the lignocellulosic ion exchange materials to separate a smaller particle size fraction This step is useful for creating pellets that have smooth surfaces with very low amounts of fines. The particle size of the milled and sifted fraction of lignocellulosic material should be small enough to pass through a sieve having 1 millimeter openings, preferably small enough to pass through a sieve having less than 0.8 millimeter openings, and most preferably small enough to pass through a sieve having 0.3 millimeter openings.

Step 3 of a process for preparing pelleted lignocellulosic ion exchange materials involves dry blending of the optionally milled and sifted ion adsorbing lignocellulosic materials with a binder and optionally an anti-microbial additive. The blending operation can take place in any conventional batch or continuous dry blending apparatus. The present invention involves the use of a water-insoluble binder or a binder that can be rendered water-insoluble through the heating involved in the subsequent baking step. A single binder material or a combination of binder materials can be used. Examples of such binders include vital wheat gluten, wheat gliadin, isolated soybean protein, corn protein, rice protein, and proteins from other plant and animal sources. The best binders for this invention are those which are both naturally insoluble in water, are sticky when mixed with an activator, and are rendered completely insoluble upon heating in a baking step.

In step 3 of the present invention, the binder materials are blended with the ion absorbing lignocellulosic materials at a ratio of at least 1 part binder materials to 10 parts lignocellulosic material but not to exceed 1 part binder materials to 1 part lignocellulosic material. Preferably, the binder materials are blended with the ion absorbing materials in the range of about 1 part binder to 1.5 parts lignocellulosic material to 1 part binder to 6 parts lignocellulosic material.

After dry blending follows step 4 of a process for preparing pelleted lignocellulosic ion exchange materials which involves adding a liquid to the dry blend of binder materials and ion absorbing ion exchange material to activate the binder and cause it to become sticky and creating a continuous matrix of binder material in which are embedded particles of lignocellulosic ion exchange material. In the case of most of the binder materials described in the present invention, water is the most appropriate liquid binder activator. In some cases other liquid binder activators may be appropriate such as ethanol, acid solutions, base solutions, or salt solutions may be appropriate. The liquid binder activator is added to the dry blend during mixing in either a batch or continuous manner. Conventional batch or continuous mixing apparatus can be used. It is preferable that the liquid binder activator be added in small droplets that are formed either by mechanical atomization or air-assisted atomization to assist in uniform distribution of the liquid binder activator over the dry mix. The mixing time required in the present invention is at least 5 seconds. More preferably, the mixing time is from about 30 seconds to 5 minutes. Most preferably, the mixing time is from about 90 seconds to 4 minutes. The quantity of liquid binder activator used is from about 1 part liquid binder activator to 1 part binder to about 5 parts liquid binder activator to about 1 part binder. Preferably the quantity of liquid binder activator used is from about 1.5 parts liquid binder activator to 1 part binder to about 4 parts liquid binder activator to 1 part binder. Most preferably, the quantity liquid binder activator used is from about 2 parts liquid binder activator to 1 part binder to about 3 parts liquid binder activator to 1 part liquid binder.

Step 5 of a process for preparing pelleted lignocellulosic ion exchange materials involves extruding the mixed material using a conventional piston, single-screw or twin-screw extrusion apparatus. At the discharge end of the extrusion device, a die is fixed through which the material is extruded. The openings in this die are typically round and have a diameter of at least about 0.5 millimeters but not to exceed about 10 millimeters. Preferably, the opening diameter is at least about 1 millimeter but not exceeding about 5 millimeters. Most preferably, the opening diameter is at least 1.5 millimeters but not exceeding about 4 millimeters.

Step 6 of a process for preparing pelleted lignocellulosic ion exchange materials involves cutting the material that is forced through the die to form a pellet. Cutting is accomplished by the conventional means of a rotating cutter at the die face whereby the product is cut just as it exits the die openings or by down-stream cutting well after the product exits the die opening. In some cases, the extruded material may be sticky. In these instances, the present invention provides for a cutting aid to be applied to the product and the cutting device to help prevent the product from sticking to itself or to the cutting apparatus. This cutting aid may be liquid or a dry powder. Liquids that have been found useful are water, dilute acid solutions, dilute base solutions, ethanol and salt solutions. Powders that have been found useful are starch, flour, talcum powder, or other similar powder materials with particle sizes similar to those named here. The length of the cut pellets is equal to about 0.5 to about 5 times the die opening diameter. Preferably, the length of cut is about 0.75 to about 2 times the opening diameter.

Step 7 of a process for preparing pelleted lignocellulosic ion exchange materials involves baking the pellets in a device where heating and drying is accomplished. The baking apparatus used is of the conventional type in either batch or continuous flow. The baking process is carried out under regulated time and temperature conditions. However, the most important aspect of the baking process is that the pellets reach a temperature sufficient to completely denature and set the binder material thus rendering it insoluble in water. In this invention, the maximum temperature that the pellets reach in the baking process should be at least about 60° C. More preferably, the maximum pellet temperature should be at least about 90° C. Most preferably, the maximum pellet temperature should be at least about 110° C.

The preferred embodiment of the present invention is further expressed by the following examples.

### EXAMPLE 1

For the following example, five samples of pelleted lignocellulosic ion exchange materials were prepared as follows. A lignocellulosic ion exchange material consisting of acid modified soybean hulls was obtained from CleanWater Solutions, LLC, of Eau Claire, Wis. having a batch number of X10A2 prepared in September, 2006. The acid modified soybean hulls were milled using an impact mill trade name Whisper Mill Model 2000 manufactured by Creative Technologies, Salt Lake City, Utah. The milled acid modified soy hulls were separated into two fractions using a US Standard 80 mesh sieve which has 0.177 millimeter openings.

The acid modified soybean hulls passing through the 0.177 millimeter sieve openings was dry blended with a binder material of the type and at the ratios specified in Table 1. In all cases 1 part binder was used. Two binder materials were used. The first type was vital wheat gluten, designated “VWG” in Table 1. The second type of binder used was a mixture of 1 part vital wheat gluten to 0.4 parts Arise 6000 which is a modified wheat gluten product manufactured by MGP Ingredients, Atchison, Kans. and designated “VWG/A6000” in Table 1. After dry blending, a liquid binder activator, water, was added at a ratio specified in Table 1. Two different water addition methods were used. In some cases, designated “pour” in Table 1, the water was added slowly in a small stream while mixing in the Kitchen Aid mixer over the course of about 3 minutes to form a loose dough-like material. In other cases, designated “atomize” in Table 1, the water was added using a hand pump spray mist bottle to create atomized water droplets while mixing in the Kitchen Aid mixer over the course of about 3 minutes to form a loose dough-like material. After mixing, the material was extruded using a Kitchen Aid meat grinder attachment using a die with either 6.4 millimeter or 4.7 millimeter diameter round openings as indicated in Table 1. The extruded strands were collected and cut into pellets by hand using scissors so that the pellet length is equal to approximately the pellet diameter. In some cases because the strands were quite sticky, good pellet separation was maintained by dipping the scissors into a 4% solution of 5.0 N acidic calcium sulfate (pHresh Technologies, LLC, Sabetha, Kans.) and water. This cutting aid is indicated by Table 1 either by “ACS” or by “None”. After cutting the pellets were baked in an oven for 20 minutes at 135C. The maximum pellet temperature reached during the baking process was not measured for these samples.

TABLE 1

| | Parts | | Water to | Water | | |
|---|---|---|---|---|---|---|
| | Soybean | | Binder | Addition | Die | |
| Sample ID | Hulls | Binder Type | Ratio | Method | Size | Cutting Aid |
| 061108-008 | 1 | VWG | 1.5 | Pour | 6.4 mm | ACS |
| 061108-009 | 1.5 | VWG/A6000 | 1.38 | Pour | 6.4 mm | ACS |
| 070110-001 | 2.3 | VWG | 1.53 | Atomize | 4.7 mm | None |
| 070110-003 | 3.2 | VWG | 2.08 | Atomize | 4.7 mm | None |
| 070110-007 | 1.5 | VWG | 1.5 | Atomize | 4.7 mm | None |

The pellets generated as shown in Table 1 were analyzed for copper ion adsorption by contacting about 0.5 grams of pellets with 50 ml of buffer solution containing about 1300 ppm of copper ions. After several hours, the copper ion concentration in the water was measured by extracting a small sample through a 0.45 micron filter. Copper ion concentration was measured using a Hach pocket calorimeter. The copper ion concentration in the buffer after extraction was compared to the copper ion concentration in buffer before extraction and the cation exchange capacity (CEC) of the pellets was calculated in units of milliequivalent per 100 grams (MEQ/100 g) with results shown in Table 2.

Based on the dilution ratio of the acid-modified soy hulls with binder, and a CEC of non-pelletized acid-modified soy hulls of 181, a ratio of actual CEC versus expected CEC was calculated and indicated in Table 2.

TABLE 2

| | CEC | CEC Ratio to |
|---|---|---|
| Sample ID | (MEQ/100 g) | Expected |
| 061108-008 | 81.7 | 0.90 |
| 061108-009 | 122.7 | 1.13 |
| 070110-001 | 121.6 | 0.96 |
| 070110-003 | 111.2 | 0.77 |
| 070110-007 | 75.5 | .070 |

Three of the samples in this example were further tested by following the first adsorption cycle with a regeneration using 0.1 N hydrochloric acid. The regeneration was followed with a second adsorption cycle as described above with the CEC measured as described above. This was repeated for a total of four adsorption cycles. The CEC results of this test are shown in Table 3.

TABLE 3

| | Cycle 1 CEC | Cycle 2 CEC | Cycle 3 CEC | |
|---|---|---|---|---|
| | (MEQ/ | (MEQ/ | (MEQ/ | Cycle 4 CEC |
| Sample ID | 100 g) | 100 g) | 100 g) | (MEQ/100 g) |
| 070110-001 | 121.6 | 66.6 | 108.7 | 64.7 |
| 070110-003 | 111.2 | 111.8 | 105.9 | 70.5 |
| 070110-007 | 75.5 | 81.6 | 121.3 | 59.5 |

### EXAMPLE 2

For the following example, three samples of pelleted lignocellulosic ion exchange materials containing an water insoluble anti-microbial additive were prepared as follows. A lignocellulosic ion exchange material consisting of acid modified soybean hulls was obtained from CleanWater Solutions, LLC, of Eau Claire, Wis. having a batch number of X10A2 prepared in September, 2006. The acid modified soybean hulls were milled using an impact mill trade name Whisper Mill Model 2000 manufactured by Creative Technologies, Salt Lake City, Utah. The milled acid modified soy hulls were separated into two fractions using a US Standard 80 mesh sieve which has 0.177 millimeter openings.

The acid modified soybean hulls passing through the 0.177 millimeter sieve openings was dry blended with vital wheat gluten binder material at a ratio of 1 part binder to 3.2 parts acid modified soybean hulls. Also dry blended with the vital wheat gluten and the acid modified soybean hulls was a water-insoluble anti-microbial material, chitosan, tradename ChitoClear provided by Primex ehf., Siglufjordur, Iceland. Chitosan was added to samples at a ratio of either zero (control) or 1% of the complete wet mix. The specific type of chitosan used is indicated in Table 4. After dry blending, a liquid binder activator, water, was added at a ratio of 2.4 parts water to 1 part binder using a hand pump spray mist bottle to create atomized water droplets while mixing in the Kitchen Aid mixer over the course of about 3 minutes to form a loose dough-like material. After mixing, the material was extruded using a Kitchen Aid meat grinder attachment using a die with 4.7 millimeter diameter round openings. The extruded strands were collected and cut into pellets by hand using scissors so that the pellet length is equal to approximately the pellet diameter. After cutting the pellets were baked in an oven for 20 minutes at 135C. The maximum pellet temperature reached during baking is indicated in Table 4.

TABLE 4

| | Chitosan | Chitosan | Maximum Temp |
|---|---|---|---|
| Sample ID | Type | Level | during Baking |
| 070216-001 | N/A | 0% | 118° C. |
| 070216-002 | fg95LV | 1% | 118° C. |
| 070216-002 | fg95ULV | 1% | 119° C. |

After preparation, these samples were added to an excess of water and left open to the air over night to be inoculated with naturally occurring mold and bacteria. Then they were closed and observed on intervals. At observations made 2 months after preparation, the hydrated samples showed no evidence of mold or microbial growth.

1. A method for preparing lignocellulosic ion exchange materials comprising the steps of blending lignocellulosic ion exchange materials with a binder, adding a liquid binder activator to said blend, extruding said blend of said activator, said binder, and said lignocellulosic ion exchange materials to form an extrudate, cutting said extrudate into pellets, and baking said pellets.

2. The method of claim 1 where said lignocellulosic ion exchange material is selected from the group comprised by soybean hulls, cotton seed hulls, rice hulls, sugarcane bagasse, rice straw, rice bran, corn bran, almond hulls, almond shells, macadamia nut hulls, peanut hulls, corn cobs, pecan shells, English walnut shells, and black walnut shells.

3. The method of claim 1 where said lignocellulosic ion exchange material has been modified to increase its ion exchange capacity.

4. The method of claim 1 where said lignocellulosic ion exchange material is soybean hulls.

5. The method of claim 4 where said soybean hulls have been acid-modified with citric acid.

6. The method of claim 1 where said lignocellulosic materials are sifted to separate a smaller particle size fraction prior to blending with said binder.

7. The method of claim 6 where said smaller particle size fraction has a particle size less than about 1 millimeter.

8. The method of claim 7 where said particle size is less than about 0.8 millimeters.

9. The method of claim 8 where said particle size is less than about 0.3 millimeters.

10. The method of claim 1 where said lignocellulosic materials are milled prior to blending with said binder.

11. The method of claim 10 where said milled lignocellulosic materials have a particle size less than about 1 millimeter.

12. The method of claim 11 where particle size is less than about 0.8 millimeters.

13. The method of claim 12 where said particle size is less than about 0.3 millimeters.

14. The method of claim 10 where said milled lignocellulosic materials are sifted to separate a smaller particle size fraction.

15. The method of claim 14 where said smaller particle size fraction has a particle size less than about 1 millimeter

16. The method of claim 15 where said particle size is less than about 0.8 millimeters.

17. The method of claim 16 where said particle size is less than about 0.3 millimeters.

18. The method of claim 1 where said binder is composed of one or more substances selected from the group comprised by vital wheat gluten, wheat gliadin, isolated soybean protein, corn protein, and rice protein.

19. The method of claim 18 where said binder is composed of a combination of vital wheat gluten and wheat gliadin.

20. The method of claim 18 where said binder is vital wheat gluten.

21. The method of claim 1 where said binder is blended with said lignocellulosic ion exchange material at a ratio from about 1 part binder to 10 parts ion absorbing lignocellulosic material to about 1 part binder to 1 part ion absorbing lignocellulosic material.

22. The method of claim 21 where said ratio of binder material to ion absorbing lignocellulosic material is from about 1 to 1.5 to about 1 to 6.

23. The method of claim 1 where said binder activator is selected from the group consisting of water, ethanol, dilute acid solutions, dilute base solutions, and salt solutions.

24. The method of claim 23 where said binder activator is water.

25. The method of claim 1 where the ratio of said binder activator to said binder is from about 1 to 1 to about 5 to 1.

26. The method of claim 25 where the ratio of said binder activator to said binder is from about 1.5 to 1 to about 4 to 1.

27. The method of claim 26 where the ratio of said binder activator to said binder is from about 2 to 1 to about 3 to 1.

28. The method of claim 1 where said binder activator is added to said blend by atomizing the binder activator into small droplets.

29. The method claim 1 where said binder activator, said binder, and said ion adsorbing lignocellulosic materials is blended for a period of at least about 5 seconds.

30. The method of claim 29 where said blending period is from about 30 seconds to about 5 minutes.

31. The method of claim 30 where said blending period is from about 90 seconds to about 4 minutes.

32. The method of claim 1 where said extruding is accomplished using a piston or screw type extruding device.

33. The method of claim 32 where said screw type extruding device is a twin screw extruder.

34. The method of claim 32 where said screw type extruding device is a single screw extruder.

35. The method of claim 32 where the discharge end of said extruding device is capped with a die plate, said die plate having openings in it to form said extrudate.

36. The method of claim 35 where said openings are round openings having a diameter and said diameter is from about 0.5 millimeters to about 10 millimeters.

37. The method of claim 36 where said diameter is from about 1 millimeter to about 5 millimeters.

38. The method of claim 37 where said diameter is from about 1.5 millimeters to about 4 millimeters.

39. The method of claim 1 where said cutting of said extrudate results in said pellets, said pellets having a diameter dimension and a length dimension.

40. The method of claim 39 where the ratio of said length dimension to said diameter dimension is from about 0.5 to about 5.

41. The method of claim 40 where said ratio is from about 0.75 to about 2.

42. The method of claim 1 where said baking step results in the temperature of said pellets reaches at least about 60° C.

43. The method of claim 42 where said temperature reaches at least about 90° C.

44. The method of claim 43 where said temperature reach at least about 110° C.

45. The method of claim 1 where a water-insoluble antimicrobial material is added in said mixing step where said binder is mixed with said lignocellulosic ion exchange material.

46. The method of claim 45 where the quantity of said water-insoluble anti-microbial material added is at least about 0.05% on a dry weight basis.

47. The method of claim 45 where said water insoluble antimicrobial material is chitosan.
